(19) United States
(12) Patent Application Publication
(10) Pub. No.: US 2017/0276349 A1
(43) Pub. Date: Sep. 28, 2017

(54) HEATING DEVICE EXHAUST PIPE ARRANGEMENT WITH INTEGRATED MUFFLER AND METHOD FOR PRODUCING SAME

(71) Applicant: Webasto SE, Stockdorf (DE)

(72) Inventors: Mattias Ahnsjö, Stockdorf (DE); Saskia Wild, Stockdorf (DE); Jean-Etienne Pousse, Stockdorf (DE)

(21) Appl. No.: 15/514,365

(22) PCT Filed: Sep. 2, 2015
(86) PCT No.: PCT/DE2015/100368

§ 371 Date: Mar. 24, 2017

(30) Foreign Application Priority Data
Sep. 27, 2014 (DE) 10 2014 114 060.5

(51) Int. Cl. F23J 11/08; B23P 15/00; F23M 20/00

(52) U.S. Cl. CPC F23J 11/08; F23M 20/005; B23P 15/00; F23J 2900/13003

(57) ABSTRACT

Provided is a heating device exhaust gas arrangement with an integrated sound suppressor, having: a rigid exhaust gas pipe (1) which is made by bending and longitudinally welding a perforated metal sheet and which has an un-perforated, curved first pipe section (2), an un-perforated second pipe section (3) and, formed integrally with the first pipe section (2) and the second pipe section (3), a perforated sound suppressor section (4) between the first pipe section (2) and the second pipe section (3), and a sound suppressor housing (5) which externally covers the perforated sound suppressor section (4) and which is arranged such that the first pipe section (2) and the second pipe section (3) both extend at least predominantly outside the sound suppressor housing (5).

The present invention relates to a heating device exhaust pipe arrangement with an integrated muffler, to a mobile fuel-operated heating device having a heating device exhaust pipe arrangement of this kind, and to a method for producing a heating device exhaust pipe arrangement.

In mobile heating devices which are operated with fuel, of the kind which are used especially in parking heaters or auxiliary heaters in vehicles, use is usually made of burner arrangements in which the fuel is converted with supplied combustion air in a combustion chamber with the release of heat. Here, conversion generally involves flaming combustion, although partially or fully catalytic conversion is also possible, in principle. The hot exhaust gases which are formed during combustion are usually passed through a heat exchanger in order to transfer as much as possible of the heat released to a medium to be heated, and then discharged via an exhaust line.

In the present context, the term “mobile heating device” is taken to mean a heating device which is designed for use in mobile applications and is adapted accordingly. In particular, this means that it is transportable (optionally being installed in a fixed manner in a vehicle or accommodated therein solely for transportation) and is not designed exclusively for permanent stationary use, as is the case when heating a building, for example. The mobile heating device can also be installed in a fixed manner in a vehicle (land vehicle, ship etc.), especially in a land vehicle. In particular, it can be designed for heating a vehicle interior, e.g. that of a land vehicle, watercraft or aircraft, and of a partially open space of the kind which can be found on ships, especially yachts, for example. It is also possible for the mobile heating device to be used temporarily for stationary applications, e.g. in large tents, containers (e.g. construction containers) etc. In particular, the mobile heating device can be designed as a parking heater or auxiliary heater for a land vehicle, e.g. for a caravan, a mobile home, a bus, a car etc.

In order to avoid unwanted noise pollution by the exhaust gases flowing out of a mobile heating device of this kind, one known practice is to arrange a muffler in an exhaust line of the mobile heating device. In the case of known mobile heating devices, the muffler is usually connected to flexible exhaust pipe lengths (especially in the case of retrofitting), e.g. by means of clamps, or, in the case of rigid exhaust pipe arrangements of the kind which are used, in particular, as original equipment, bent flexurally stiff exhaust pipe lengths are welded to the inlet end and the outlet end of the muffler.

It is the object of the present invention to provide an improved heating device exhaust pipe arrangement and an improved mobile, fuel-operated heating device.

The object is achieved by a heating device exhaust pipe arrangement with an integrated muffler as claimed in claim 1. Advantageous developments are given in the dependent claims.

The heating device exhaust pipe arrangement with an integrated muffler has a flexurally stiff exhaust pipe, which is manufactured from a perforated metal sheet by round bending and longitudinal welding and has an unperforated curved first pipe section, an unperforated second pipe section and, formed integrally with the first pipe section and the second pipe section, a perforated muffler section between the first pipe section and the second pipe section, and a muffler housing, which externally covers the perforated muffler section and is arranged in such a way that the first pipe section and the second pipe section each extend at least predominantly outside the muffler housing.

Since the muffler is integrated into the heating device exhaust pipe arrangement, the muffler is thus formed directly as part of the exhaust pipe and it does not have to be connected separately to exhaust pipe lengths, which results in a considerably reduced assembly effort. Since the exhaust pipe which has the muffler section is manufactured from a perforated metal sheet by round bending and longitudinal welding, particularly low-cost production is furthermore possible. In particular, the perforations for the muffler section can be formed at low cost in the metal sheet, e.g. by punching, before the round bending and longitudinal welding to give the tubular shape. By virtue of the integral formation of the exhaust pipe, which has the unperforated curved first pipe section, the unperforated second pipe section and the muffler section, the entire unit, i.e. the heating device exhaust pipe arrangement, comprising the muffler and the exhaust pipe sections upstream and downstream of the muffler can be produced at very low cost. The unperforated second pipe section can preferably also be of curved design. In this way, moreover, a significantly more compact design is achieved in comparison with separate formation of the muffler and exhaust pipe lengths connected thereto, and the resulting tolerances can be reduced. By virtue of the flexurally stiff design of the exhaust pipe with the integrated muffler, a self-supporting construction, which is particularly simple to fit, is provided at the same time. Since at least the first pipe section is curved, securing to a mobile fuel-operated heating device without additional elbow elements is furthermore made possible, even under difficult installation conditions. This applies to an even greater extent especially when the unperforated second pipe section is also curved.

According to a development, the perforated muffler section extends over at most 40% of the total length of the exhaust pipe. Preferably, the perforated muffler section extends over at most 35% of the total length of the exhaust pipe. In this case, the unperforated curved pipe sections have a length which allows reliable installation without additional intermediate pieces, even under difficult installation conditions. Here, the length of the exhaust pipe or of the individual sections of the exhaust pipe is taken to mean the length of the flow path, measured in the center of the pipe.

According to a development, at least one of the curved first pipe section and the second pipe section has a length of at least 80% of the length of the perforated muffler section. In this case, the first pipe section and/or the second pipe section has/have a length which allows reliable installation of the heating device exhaust pipe arrangement on a mobile fuel-operated heating device without additional intermediate pieces. The curved first pipe section and the second pipe section preferably each have a length of at least 50% of the length of the perforated muffler section.

According to a development, at least the curved first pipe section has a curvature >90°, preferably >120°. Here, curvature is taken to mean the curvature measured in the direction of extent of the exhaust pipe. Given such a large curvature of the curved pipe section, installation of the heating device exhaust pipe arrangement is made possible even with a very small available installation space. The second pipe section can preferably also have such a curvature.

The muffler housing is preferably welded to the outside of the exhaust pipe. In particular, it is possible in a simple and low-cost way for the muffler housing to be connected by spot welding to the muffler section or to a directly adjoining region of the first unperforated pipe section and/or of the second unperforated pipe section.

If the muffler housing has two half shells of identical design, particularly low-cost production is made possible, in which the half shells can be produced in large numbers and installation is very simple.

According to a development, a noise-absorbing insulating material is arranged between the inside of the muffler housing and the outside of the perforated muffler section in order to achieve as good suppression of noise as possible. Here, the insulating material can preferably comprise mineral wool and/or glass wool, in particular can be formed by mineral wool and/or glass wool.

The exhaust pipe is preferably manufactured from a temperature-stable steel sheet. In this case, particularly low-cost production is made possible in a simple manner. As an alternative, production from other materials, such as aluminum or an aluminum alloy in particular, is also possible, for example.

The object is also achieved by a mobile fuel-operated heating device having a heating device exhaust pipe arrangement of this kind as claimed in claim 11.

The object is also achieved by a method for producing a heating device exhaust pipe arrangement with an integrated muffler as claimed in claim 12. Advantageous developments are given in the dependent claims.

The method has the following steps:
formation of a flexurally stiff pipe having a first unperforated pipe section, a second unperforated pipe section and a perforated muffler section arranged therebetween by round bending and longitudinal welding of a regionally perforated metal sheet;
inelastic deforming at least of the first unperforated pipe section to form a flexurally stiff exhaust pipe having an unperforated curved first pipe section, an unperforated second pipe section and a perforated muffler section situated therebetween,
securing a muffler housing in the region of the perforated muffler section in such a way that the unperforated curved first pipe section and the unperforated second pipe section extend at least predominantly outside the muffler housing.

By means of the method, the advantages described above in respect of the heating device exhaust pipe arrangement with an integrated muffler are achieved.

Since a muffler integrated into the heating device exhaust pipe arrangement is produced by means of the method, the muffler is thus formed directly as part of the exhaust pipe and it does not have to be connected separately to exhaust pipe lengths, resulting in a considerably reduced assembly effort. Since the exhaust pipe which has the muffler section is manufactured from a perforated metal sheet by round bending and longitudinal welding, production is particularly low-cost. In particular, the perforations for the muffler section can be formed at low cost in the metal sheet, e.g. by punching, before the round bending and longitudinal welding to give the tubular shape. By virtue of the integral formation of the exhaust pipe, which has the unperforated curved first pipe section, the unperforated second pipe section and the muffler section, a significantly more compact design is achieved in comparison with separate formation of the muffler and exhaust pipe lengths connected thereto, and the resulting tolerances can be reduced. Inelastic deforming of the second unperforated pipe section to form an unperforated curved second pipe section can preferably also be performed. By virtue of the flexurally stiff design of the exhaust pipe with the integrated muffler, a self-supporting construction, which is particularly simple to fit, is provided at the same time. Since the first pipe section is curved, securing to a mobile fuel-operated heating device without additional elbow elements is furthermore made possible, even under difficult installation conditions. This is achieved even better especially when the second pipe section is also curved.

According to a development, the muffler housing is welded to the exhaust pipe. Here, welding can be accomplished in a simple and low-cost way by spot welding, in particular. In particular, the muffler housing can be welded to the muffler section or to a region of the first and/or second pipe section directly adjoining said muffler section.

According to a development, a sound-absorbing insulating material is introduced between an inside of the muffler housing and an outside of the perforated muffler section. In this case, the sound-absorbing insulating material should be introduced, in particular, before the welding of the muffler housing.

Further advantages and developments will become apparent from the following description of an illustrative embodiment with reference to the attached drawings.

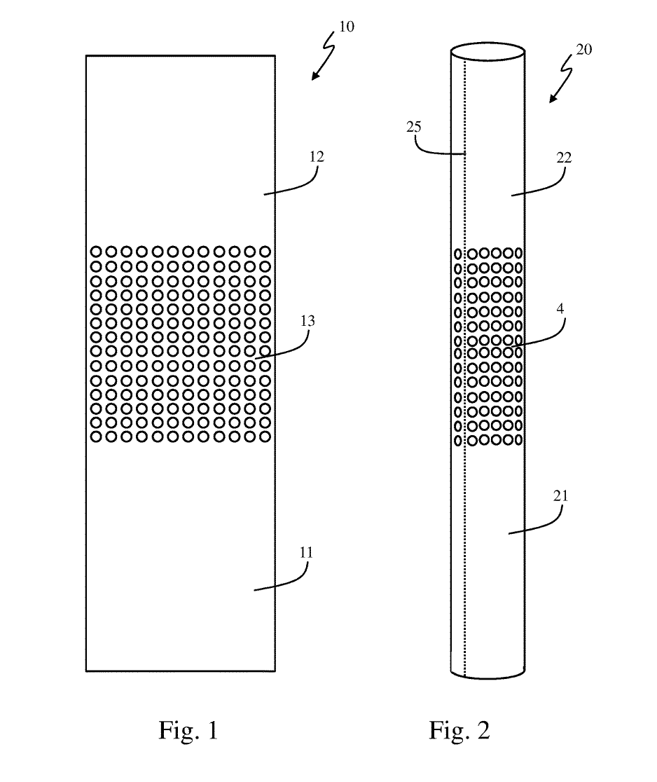

FIG. 1 is a schematic illustration of a regionally perforated metal sheet of the kind used in the method according to the invention.

FIG. 2 is a schematic illustration of a flexurally stiff metal pipe, which is manufactured from the perforated metal sheet in FIG. 1 by round bending and longitudinal welding and has a first unperforated pipe section, a second unperforated pipe section and a perforated muffler section arranged therebetween.

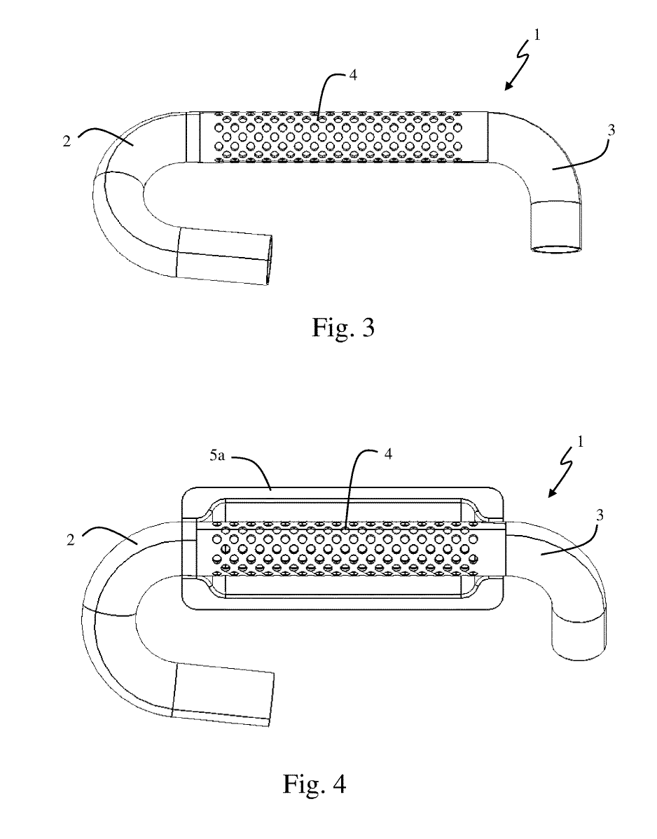

FIG. 3 is a schematic illustration of a flexurally stiff exhaust pipe according to the embodiment.

FIG. 4 is a schematic illustration of the flexurally stiff exhaust pipe with a half shell of a muffler housing.

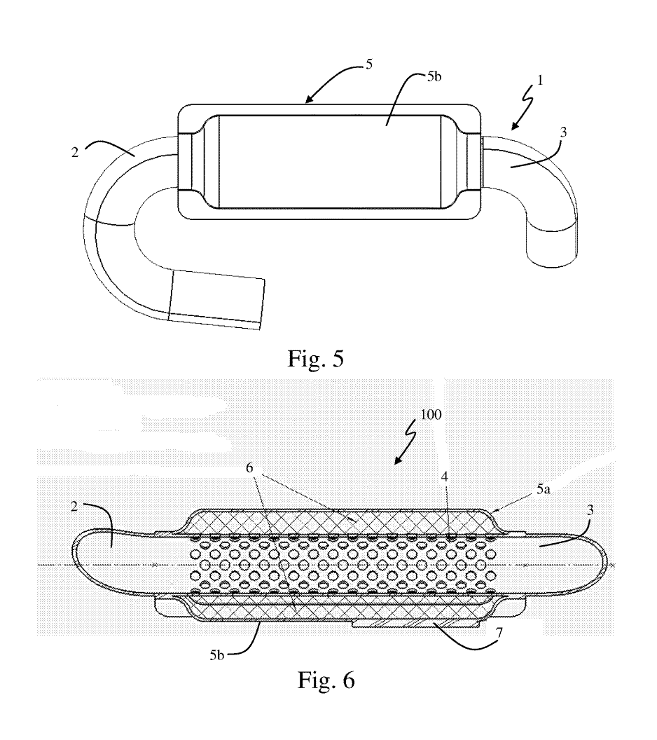

FIG. 5 is a schematic illustration of the exhaust pipe with a muffler housing secured thereon.

FIG. 6 is a schematic section through a heating device exhaust pipe arrangement with an integrated muffler according to the embodiment.

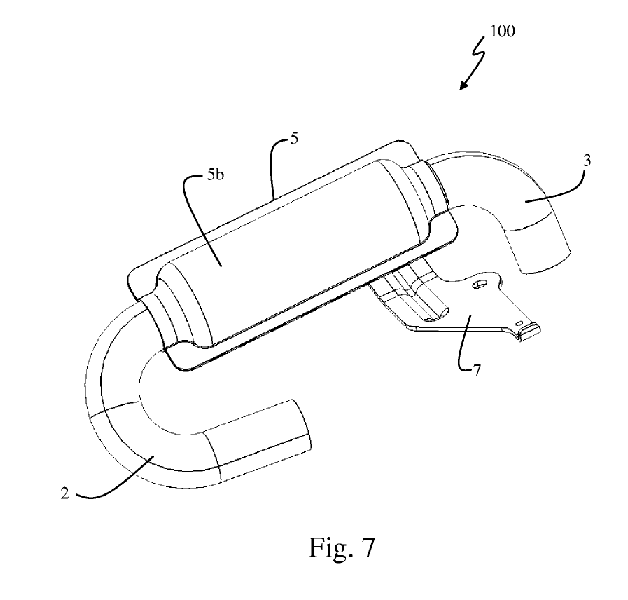

FIG. 7 is a schematic perspective illustration of the heating device exhaust pipe arrangement.

An embodiment of the heating device exhaust pipe arrangement 100 with integrated muffler is described below with reference to FIG. 1 to FIG. 7.

The heating device exhaust pipe arrangement 100 according to the embodiment is designed specifically for a mobile fuel-operated heating device, in particular for a vehicle heating device of the kind typically used in a parking heater or auxiliary heater, for example.

The heating device exhaust pipe arrangement 100 with integrated muffler has an inflexible exhaust pipe 1, as illustrated in FIG. 3. The exhaust pipe 1 is formed from metal, in particular from sheet steel consisting of a temperature-stable steel grade in the specifically illustrated embodiment. The exhaust pipe 1 has a curved first pipe section 2, a curved second pipe section 3 and a muffler section 4 formed between the curved first pipe section 2 and the curved second pipe section 3. In this case, the muffler section 4 is formed integrally with the curved first pipe section 2 and the curved second pipe section 3 from the metal sheet. In the muffler section 4, the wall of the exhaust pipe 1 is perforated, whereas the curved first pipe section 2 and the curved second pipe section 3 are unperforated, i.e. are formed with a continuous pipe wall. In the perforated muffler section 4, the wall of the exhaust pipe 1 is provided with a multiplicity of holes, which connect the inside of the muffler section 4 to the outside of the muffler section 4.

The unperforated curved first pipe section 2 and the unperforated curved second pipe section 3 each extend over a pipe length (measured as the flow path formed in the center of the pipe) which is at least 50% of the length of the perforated muffler section 4. In the specifically illustrated illustrative embodiment, the unperforated curved first pipe section 3 extends over a length which corresponds approximately to the length of the muffler section, and the unperforated curved second pipe section 3 thus extends over more than 80% of the length of the muffler section 4. Together, the unperforated curved first pipe section 2 and the unperforated curved second pipe section form a larger proportion of the length of the exhaust pipe 1 than the perforated muffler section 4.

In the embodiment illustrated, the unperforated curved second pipe section 3 is provided with a curvature of about 90°, for example, and the unperforated curved first pipe section 2 is provided with a significantly larger curvature, in particular a curvature >120°, or even a curvature of more than 160° in the specifically illustrated illustrative embodiment. In contrast, the perforated muffler section 4 extends at least substantially in a linear manner, being therefore of uncurved design, in the embodiment.

The exhaust pipe 1 having the unperforated curved first pipe section 2, the perforated muffler section 4 and the unperforated curved second pipe section 3 is embodied so as to be flexurally stiff, and therefore it is self-supporting, i.e. does not deform if it is secured only at one or a few points, for example. The exhaust pipe 1 is formed by round bending and longitudinal welding of a flat metal sheet 10, which has an unperforated first section 11, an unperforated second section 12 and a perforated section 13 situated therebetween, of the kind illustrated schematically in FIG. 1, for example. In particular, the holes in the perforated section 13 can be produced in the metal sheet 10 by punching, allowing particularly low-cost manufacture. The flexurally stiff pipe 20 produced by round bending and longitudinal welding is illustrated schematically in FIG. 2. As illustrated schematically in FIG. 2, the flexurally stiff pipe 20 has a weld seam 25, which extends in the longitudinal direction of the pipe 20 and which is illustrated in dashed lines in FIG. 2. It should be noted that FIG. 1 and FIG. 2 are only schematic illustrations, and the length of the unperforated sections 11 and 12 and of the perforated section 13 of the metal sheet 10 do not correspond fully to the respective lengths of the exhaust pipe 1 illustrated in FIG. 3 to FIG. 7, owing to the schematic illustration. As can be seen in FIG. 2, the flexurally stiff pipe 20 formed has an unperforated first pipe section 21, an unperforated second pipe section 22 and the muffler section 4 situated therebetween.

The flexurally stiff exhaust pipe 1 illustrated in FIG. 3 is formed by inelastic deforming of the flexurally stiff pipe 2. Here, the unperforated curved first pipe section 2 and the unperforated curved second pipe section 3 are formed by bending the unperforated pipe sections 21 and 22 using a conventional pipe bending apparatus. To produce the flexurally stiff exhaust pipe 1, the free end of the unperforated curved first pipe section 2 and/or the free end of the unperforated curved second pipe section 3 can also, in particular, be cut to the required length.

To form the heating device exhaust pipe arrangement 100 according to the embodiment, the flexurally stiff exhaust pipe 1 is provided with a muffler housing 5. In the embodiment, the muffler housing 5 has two half shells 5a, 5b of identical design to one another, which allows particularly low-cost production. In the embodiment, the muffler housing 5 is also formed from sheet metal, in particular from sheet steel. In this case, it is possible, in particular, for the half shells 5a, 5b of the muffler housing 5 to be formed from the metal sheet by deforming. The half shells 5a, 5b of the muffler housing 5 are arranged on the flexurally stiff exhaust pipe 1 in such a way that the muffler housing 5 covers the perforated muffler section 4. In this case, the muffler housing 5 surrounds the entire outer circumference of the muffler section 4, and therefore an interspace is formed between the outside of the perforated muffler section 4 and the inside of the muffler housing 5, as can be seen especially in the schematic sectional illustration in FIG. 6. Arranged in the interspace is a noise-absorbing insulating material 6, which, in particular, is formed by mineral wool in the embodiment. As an alternative or in addition, it is also possible, in particular, to use glass wool as an insulating material. However, it is also possible to use other temperature-stable and environmentally stable fiber materials.

The muffler housing 5 is connected to the outside of the flexurally stiff exhaust pipe 1 by welding. The muffler housing 5 is dimensioned in such a way that both the unperforated curved first pipe section 2 and the unperforated curved second pipe section 3 extend predominantly outside the muffler housing 5. The unperforated curved first pipe section 2 and the unperforated curved second pipe section 3 thus not only form connection pieces, protruding from the muffler housing 5, for partial lengths of an exhaust pipe but each themselves form partial lengths of the exhaust pipe. The muffler housing 5 is welded to the muffler section 4 or to regions of the unperforated curved first pipe section 2 and/or of the unperforated curved second pipe section 3 which directly adjoin said muffler section. Here, it is possible, in particular, for the welded joint between the muffler housing 5 and the exhaust pipe 1 to be formed in a simple and low-cost way by spot welding.

In the embodiment, the heating device exhaust pipe arrangement 100 with an integrated muffler furthermore has a bracket 7 for securing the heating device exhaust pipe arrangement 100, as can be seen in FIG. 6 and FIG. 7. The bracket 7 is likewise made from sheet metal and is connected to the muffler housing 5 by welding. By virtue of the flexurally stiff design of the exhaust pipe 1, the heating device exhaust pipe arrangement can be secured exclusively by means of the bracket 7, for example, and the heating device exhaust pipe arrangement 100 is held in a self-supporting manner, in particular preventing the unperforated curved first pipe section 2 or the unperforated curved second pipe section 3 from moving relative to the integrated muffler formed by the muffler section 4 and the muffler housing 5. As a result, the welded joint between the exhaust pipe 1 and the muffler housing 5 is not acted upon by high forces, and therefore this joint is very stable and durable.

Since the muffler section 4 is designed as part of the exhaust pipe 1, the exhaust pipe 1 can be designed to be curved directly adjoining the muffler housing 5, thus allowing a significantly more compact configuration as compared with separate formation of a muffler and partial exhaust pipe lengths secured thereon, e.g. by means of connection pieces.

In a method for producing the heating device exhaust pipe arrangement 100 according to the embodiment, a flexurally stiff pipe 20 having a first unperforated pipe section 21, a second unperforated pipe section 22 and a perforated muffler section 4 arranged therebetween, as illustrated schematically in FIG. 2, is formed by round bending and longitudinal welding of a regionally perforated metal sheet 10, which is illustrated schematically in FIG. 1.

The first unperforated pipe section 21 and the second unperforated pipe section 22 are then deformed inelastically, this being carried out in a conventional pipe bending apparatus, for example. In this way, the flexurally stiff exhaust pipe 1 with the unperforated curved first pipe section 2, the unperforated curved second pipe section 3 and the perforated muffler section 4 situated therebetween is formed, being illustrated schematically in FIG. 3.

The muffler housing 5 is then secured on the exhaust pipe 1 in the region of the perforated muffler section 4 in such a way that the unperforated curved first pipe section 2 and the unperforated curved second pipe section 3 extend at least predominantly outside the muffler housing 5. In the illustrative embodiment, securing is accomplished, in particular, by welding, in particular by spot welding. Before or during the securing of the muffler housing 5, the sound-absorbing insulating material 6 is arranged between the inside of the muffler housing 5 and the outside of the perforated muffler section 4. The bracket 7 can be connected to one of the two half shells 5a, 5b even before the muffler housing 5 is secured, for example, or, alternatively, can be secured only after the muffler housing 5 has been secured on the flexurally stiff exhaust pipe 1. The securing of the bracket 7 can also preferably be accomplished by spot welding.

1. A heating device exhaust pipe arrangement with an integrated muffler, having:
a flexurally stiff exhaust pipe, which is manufactured from a perforated metal sheet by round bending and longitudinal welding and has an unperforated curved first pipe section, an unperforated second pipe section and, formed integrally with the first pipe section and the second pipe section, a perforated muffler section between the first pipe section and the second pipe section, and
a muffler housing, which covers the exterior of the perforated muffler section and is arranged in such a way that the first pipe section and the second pipe section each extend at least predominantly outside the muffler housing.

2. The heating device exhaust pipe arrangement as claimed in claim 1, wherein the perforated muffler section extends over at most 40% of the total length of the exhaust pipe.

3. The heating device exhaust pipe arrangement as claimed in claim 1 , wherein at least one of the curved first pipe section and the second pipe section has a length of at least 80% of the length of the perforated muffler section.

4. The heating device exhaust pipe arrangement as claimed in claim 1, wherein the curved first pipe section and the second pipe section each have a length of at least 50% of the length of the perforated muffler section.

5. The heating device exhaust pipe arrangement as claimed in claim 1, wherein at least the curved first pipe section has a curvature >90°.

6. The heating device exhaust pipe arrangement as claimed in claim 1, wherein the muffler housing is welded to the outside of the exhaust pipe.

7. The heating device exhaust pipe arrangement as claimed in claim 1, wherein the muffler housing has two half shells of identical design.

8. The heating device exhaust pipe arrangement as claimed in claim 1, wherein a noise-absorbing insulating material is arranged between the inside of the muffler housing and the outside of the perforated muffler section.

9. The heating device exhaust pipe arrangement as claimed in claim 8, wherein the insulating material comprises at least one of mineral wool and glass wool.

10. The heating device exhaust pipe arrangement as claimed in claim 1, characterized in that the exhaust pipe is manufactured from a temperature-stable steel sheet.

11. A mobile fuel-operated heating device having a heating device exhaust pipe arrangement as claimed in claim 1.

12. A method for producing a heating device exhaust pipe arrangement with an integrated muffler, comprising the following steps:
forming a flexurally stiff pipe having a first unperforated pipe section, a second unperforated pipe section and a perforated muffler section arranged therebetween by round bending and longitudinal welding of a regionally perforated metal sheet;
inelastically deforming at least of the first unperforated pipe section to form a flexurally stiff exhaust pipe having an unperforated curved first pipe section, an unperforated second pipe section and a perforated muffler section situated therebetween,
securing a muffler housing in the region of the perforated muffler section in such a way that the unperforated curved first pipe section and the unperforated second pipe section extend at least predominantly outside the muffler housing.

13. The method as claimed in claim 12, comprising the following step:
welding the muffler housing to the exhaust pipe.

14. The method as claimed in claim 12, comprising the following step:
introducing a sound-absorbing insulating material between an inside of the muffler housing and an outside of the perforated muffler section.

15. The heating device exhaust pipe arrangement as claimed in claim 1, wherein the perforated muffler section extends over at most 35% of the total length of the exhaust pipe.

16. The heating device exhaust pipe arrangement as claimed in claim 1, wherein at least the curved first pipe section has a curvature >120°.
